(19) United States
(12) Patent Application Publication
(10) Pub. No.: US 2025/0058383 A1
(43) Pub. Date: Feb. 20, 2025

(54) JIGS AND METHODS FOR DRILLING OR REAMING HOLES IN A WORKPIECE

(71) Applicant: The Boeing Company, Arlington, VA (US)

(72) Inventor: James M. Giffin, San Antonio, TX (US)

(73) Assignee: The Boeing Company, Arlington, VA (US)

(21) Appl. No.: 18/450,527

(22) Filed: Aug. 16, 2023

(51) Int. Cl. B23B 49/02

(52) U.S. Cl. CPC B23B 49/023; B23B 2247/12

(57) ABSTRACT

A jig for forming holes in a workpiece includes a body. The body includes a first jig-surface and a second jig-surface. The first jig-surface includes a jig-surface contour. The jig-surface contour is complementary to a workpiece-surface contour of a workpiece-surface of the workpiece. The second jig-surface is planar and opposite to the first jig-surface. The jig includes through holes that extend through the body between the first jig-surface and the second jig-surface for forming holes in the workpiece. Each one of the through holes includes a through-hole axis that is perpendicular to the second jig-surface and that is non-perpendicular to the first jig-surface such that each one of the holes formed in the workpiece has a hole axis that is non-perpendicular to the workpiece-surface.

### FIELD

The present disclosure relates generally to hole generation and, more particularly, to jigs and methods for drilling or reaming holes in a workpiece having a contoured surface.

### BACKGROUND

Many manufactured components require holes, which are used for a variety of purposes. For some purposes, new holes are drilled in the component. For other purposes, initial holes or preexisting holes are reamed to achieve a desired diameter. In most cases, holes are formed in a component such that a hole axis is perpendicular to the surface of the component. However, in some cases, holes need to be formed such that the hole axis is non-perpendicular to the surface. In these cases, it can be difficult to properly align and maintain a cutting tool at a desired drilling location and at a desired non-perpendicular orientation relative to the surface while forming the holes. Accordingly, those skilled in the art continue with research and development efforts in the field of hole generation.

### SUMMARY

Disclosed are examples of a jig for forming holes in a workpiece, a jig for reaming holes in a workpiece, and a method for forming holes in a workpiece. The following is a non-exhaustive list of examples, which may or may not be claimed, of the subject matter according to the present disclosure.

In an example, the disclosed jig includes a body. The body includes a first jig-surface 104 and a second jig-surface. The first jig-surface includes a jig-surface contour. The jig-surface contour is complementary to a workpiece-surface contour of a workpiece-surface of a workpiece. The second jig-surface is planar and opposite to the first jig-surface. The jig includes through holes that extend through the body between the first jig-surface and the second jig-surface for forming holes in the workpiece. Each one of the through holes includes a through-hole axis that is perpendicular to the second jig-surface and that is non-perpendicular to the first jig-surface such that each one of the holes formed in the workpiece has a hole axis that is non-perpendicular to the workpiece-surface.

In another example, the disclosed jig includes a body. The body includes a first jig-surface and a second jig-surface. The first jig-surface includes a jig-surface contour. The jig-surface contour is complementary to a workpiece-surface contour of a workpiece-surface of a workpiece. The second jig-surface is planar and opposite to the first jig-surface. The jig includes a first through hole that extends through the body between the first jig-surface and the second jig-surface for reaming a first hole in the workpiece. The jig includes a second through hole that extends through the body between the first jig-surface and the second jig-surface for reaming a second hole in the workpiece. The first through hole includes a first through-hole axis that is perpendicular to the second jig-surface and that is non-perpendicular to the first jig-surface such that the first through-hole axis and a first hole axis of the first hole are coincident or parallel to each other. The second through hole includes a second through-hole axis that is perpendicular to the second jig-surface and that is non-perpendicular to the first jig-surface such that the second through-hole axis and a second hole axis of the second hole are coincident or parallel to each other.

In an example, the disclosed method includes steps of: (1) positioning a body of a jig relative to a workpiece such that a first jig-surface is in contact with a workpiece-surface, wherein a jig-surface contour of the first jig-surface is complementary to a workpiece-surface contour of the workpiece-surface; and (2) forming holes in the workpiece using through holes that extend through the body between the first jig-surface and a second jig-surface, wherein each one of the through holes includes a through-hole axis that is perpendicular to the second jig-surface and that is non-perpendicular to the first jig-surface such that each one of the holes formed in the workpiece has a hole axis that is non-perpendicular to the workpiece-surface.

Other examples of the jig and the method will become apparent from the following detailed description, the accompanying drawings, and the appended claims.

### BRIEF DESCRIPTION OF THE DRAWINGS

FIG. 1 is a schematic, sectional view of an example of a jig for forming holes in a workpiece and an example of the workpiece;

FIG. 2 is a schematic, sectional view of an example of the jig and an example of the workpiece;

FIG. 3 is a schematic, sectional view of an example of the jig and an example of the workpiece;

FIG. 4 is a schematic, sectional view of an example of the jig for forming holes in a workpiece;

FIG. 5 is a schematic, sectional view of an example of a workpiece with holes formed using the jig;

FIG. 6 is a schematic, sectional view of an example of the jig and the workpiece;

FIG. 7 is a schematic, sectional view of an example of the jig and the workpiece;

FIG. 8 is a schematic, sectional view of an example of the jig and the workpiece;

FIG. 9 is a schematic, perspective view of an example of the jig; and

FIG. 10 is a schematic, perspective view of an example of the jig;

FIG. 11 is a schematic, sectional view of an example of the jig;

FIG. 12 is a schematic, sectional view of an example of the jig;

FIG. 13 is a schematic, block diagram of an example of the jig;

FIG. 14 is a flow diagram of an example of a method for forming a hole;

FIG. 15 is a flow diagram of an example of an aircraft manufacturing and service method; and

FIG. 16 is a schematic block diagram of an example of an aircraft.

### DETAILED DESCRIPTION

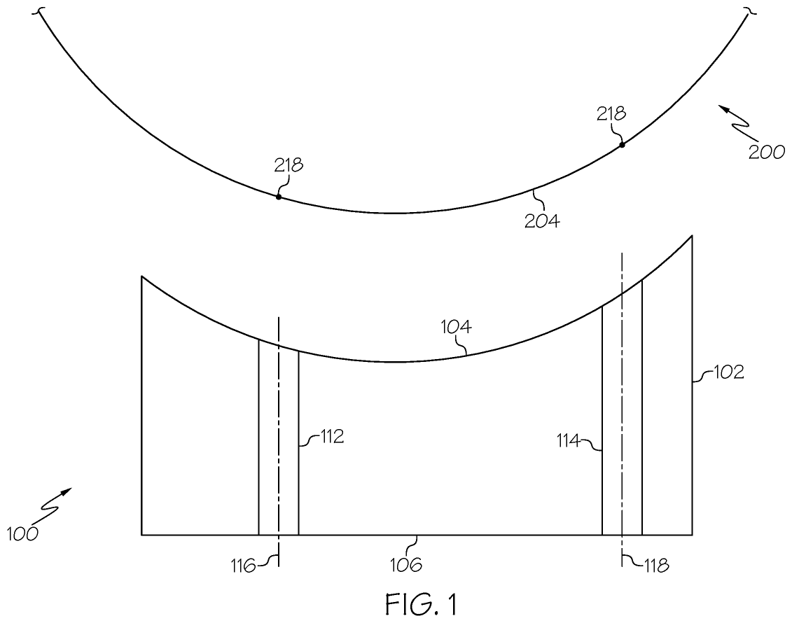

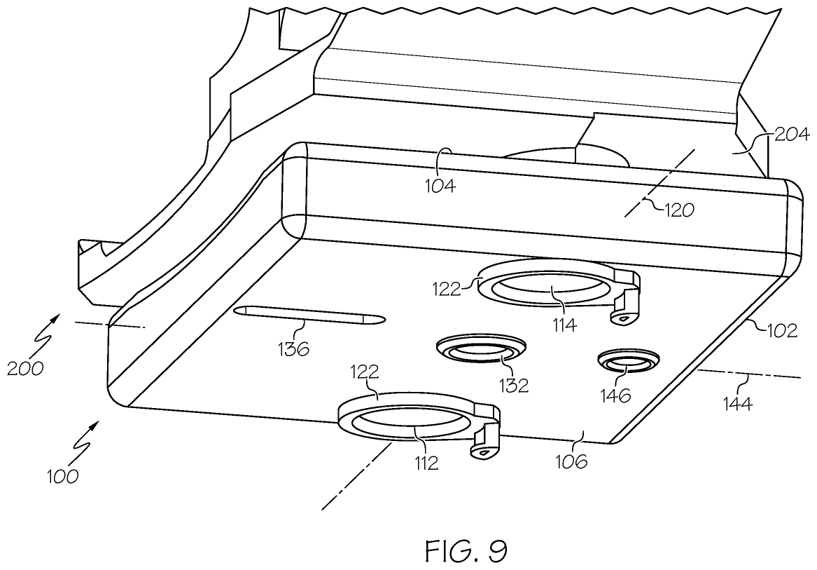

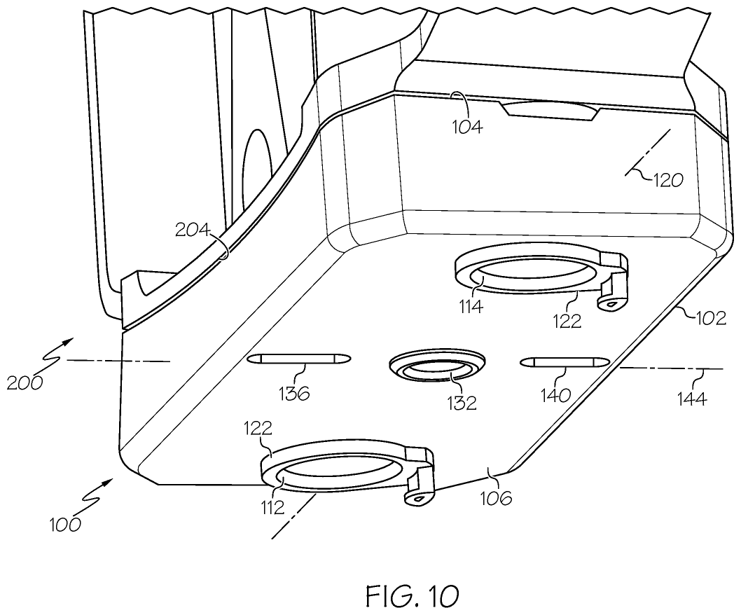

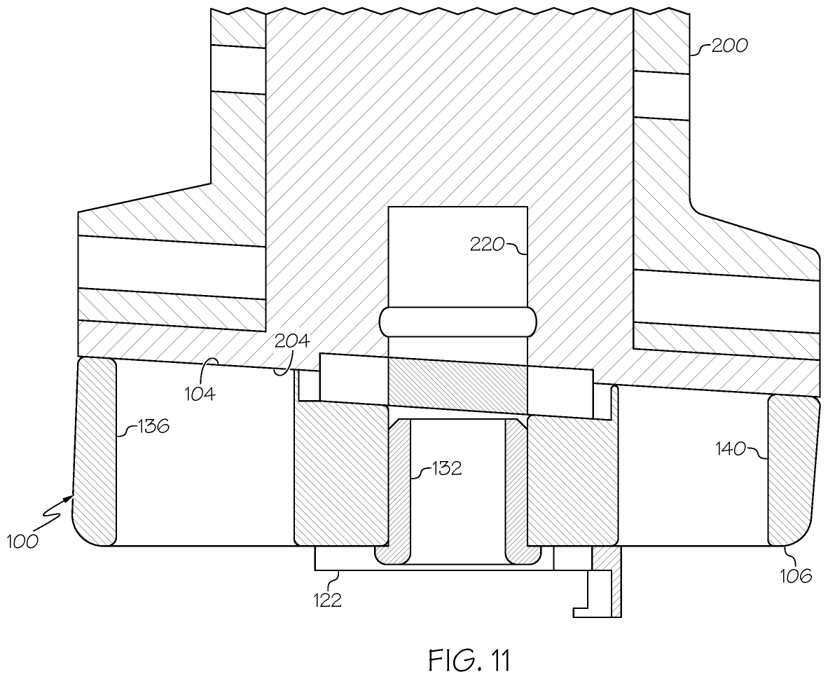

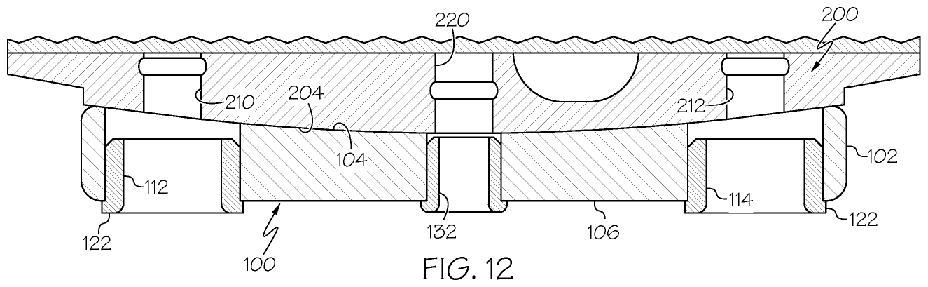

Referring generally to FIGS. 1-14, by way of examples, the present disclosure is directed to a jig 100 and a method 1000 for forming holes 202 in a workpiece 200. The jig 100 and the method 1000 enable proper alignment and orientation of the holes 202 and prevent forming (e.g., drilling or reaming) the holes 202, such as a pair of holes 202, with improper alignment or orientation.

In one or more examples, the jig 100 is configured to align to a specific instance of the workpiece 200 to facilitate the forming (e.g., drilling or reaming) of the holes 202 at a desired location relative to the workpiece 200 and at a desired orientation that is non-perpendicular to a workpiece-surface 204 of the workpiece 200, such as at an orientation that is perpendicular to horizontal. The jig 100 is engineered (e.g., designed and fabricated) to include a contoured surface that matches the surface contour of the workpiece 200 being drilled or reamed, a flat surface that is opposite the contoured surface to work off, and through holes to properly position, align, orient, and guide a cutting tool during hole formation. In one or more examples, the jig 100 also includes removable bushings that line an interior of the through holes, thereby enabling a wide variety of different bushings to be used without removing the jig 100 and losing alignment with the workpiece 200. In one or more examples, the jig 100 includes a centering location for pinning the jig 100 in place for rough alignment. In one or more examples, the jig 100 includes one or more slots for fine alignment and, optionally, securing the jig 100 in place relative to the workpiece 200. In one or more examples, the jig 100 includes a fastening location for fastening the jig 100 to the workpiece 200 after alignment.

For the purpose of the present disclosure, “forming” holes in a workpiece and similar terms or phrases mean any machining operation that uses a cutting tool, such a rotary cutting tool, to cut, drill, ream, bore, or otherwise produce a hole, increase the diameter of a hole, or change a shape of the hole in the workpiece.

FIGS. 1-13 illustrate examples of the workpiece 200. Generally, the workpiece 200 refers to or includes any object, article, structure, component, or the like upon which the hole-generating operation is performed using the jig 100 and/or according to the method 1000.

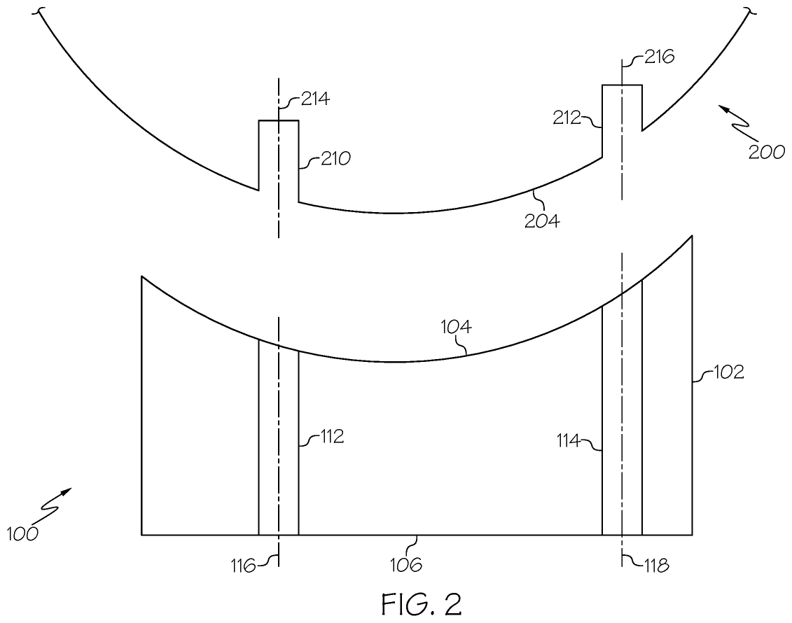

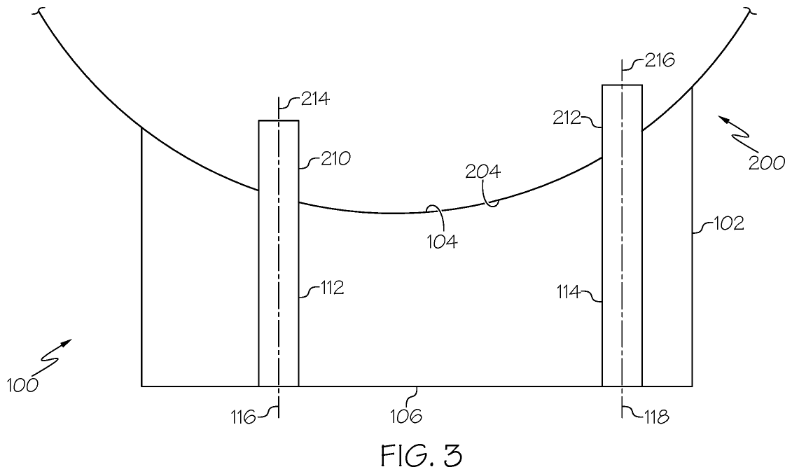

FIG. 1 schematically illustrates an example of the workpiece 200 and an example of the jig 100 used to drill the holes 202 in the workpiece 200. FIG. 2 schematically illustrates an example of the workpiece 200 and an example of the jig 100 used to ream the holes 202 in the workpiece 200. FIG. 3 schematically illustrates an example of the workpiece 200 and an example of the jig 100 after the holes 202 are formed (e.g., drilled or reamed) in the workpiece 200.

As illustrated in FIG. 1, in one or more examples, the holes 202 are not initially in the workpiece 200. As such, the holes 202 are drilled (e.g., newly formed) at the desired location and the desired orientation using the jig 100, as illustrated in FIG. 3. As illustrated in 2, in one or more examples, the holes 202 preexist in the workpiece 200. As such, the holes 202 are reamed (e.g., enlarged for dimensional accuracy or hole-surface enhancement) at the existing location and the existing orientation using the jig 100, as illustrated in FIG. 3.

Referring to FIGS. 1-13, in one or more examples, the workpiece 200 includes a workpiece-surface 204. In one or more examples, the workpiece-surface 204 includes or otherwise has a workpiece-surface contour 206. Generally, the workpiece-surface contour 206 refers to a curvature or profile of at least a portion of the workpiece-surface 204 that is non-planar or that otherwise intersects a virtual (e.g., horizontal) plane in at least two locations. In one or more examples, the workpiece-surface contour 206 refers to or includes a curvature that extends along at least one orthogonal axis. For example, the workpiece-surface contour 206 includes a curvature along an X-axis, a curvature along a Y-axis, or a curvature along the X- and Y-axes.

In one or more examples, the workpiece 200 includes or takes the form of a component of an aircraft 1200, such as a portion or component of an airframe 1202 of the aircraft 1200. In one or more examples, the workpiece 200 includes a former, frame, or bulkhead of the fuselage or barrel of the aircraft 1200. In a specific, non-limiting example, the workpiece 200 includes or takes the form of keel frame of the aircraft 1200. In these examples, the workpiece 200 has an annular shape or a semi-annular shape. The workpiece-surface contour 206 of the workpiece-surface 204 is defined by the annular shape or the semi-annular shape of the workpiece 200.

Referring still to FIGS. 1-13, disclosed are examples of the jig 100 for forming the holes 202 in the workpiece 200. The following are examples of the jig 100, according to the present disclosure. The examples of the jig 100, described herein below and illustrated in FIGS. 1-13, include a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIGS. 1-4, 6-10, 12 and 13, in one or more examples, the jig 100 includes a body 102. The body 102 includes a first jig-surface 104 and a second jig-surface 106. The jig 100 also includes through holes 108 formed in the body 102. The through holes 108 are used to align and guide a cutting tool during formation of the holes 202 in the workpiece 200.

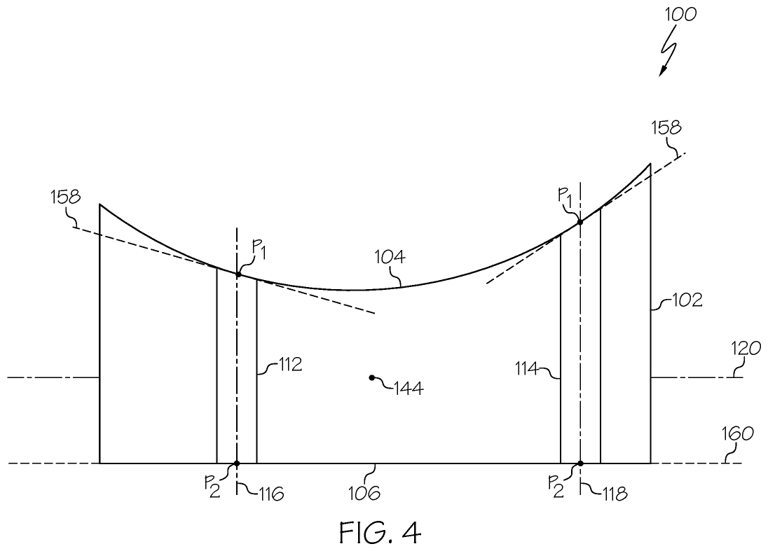

Referring to FIGS. 4, 12 and 13, the first jig-surface 104 includes a first jig-surface contour 150. Generally, the first jig-surface contour 150 refers to a surface curvature or surface profile of at least a portion of the first jig-surface 104 that is non-planar or that otherwise intersects a virtual (e.g., horizontal) plane in at least two locations. In one or more examples, the first jig-surface contour 150 refers to or includes a curvature that extends along at least one orthogonal axis. For example, the first jig-surface contour 150 includes a curvature along an X-axis, a curvature along a Y-axis, or a curvature along the X- and Y-axes.

Referring to FIGS. 1-3 and 6-13, the first jig-surface contour 150 is complementary to the workpiece-surface contour 206 of the workpiece-surface 204. The first jig-surface contour 150 being complementary to the workpiece-surface contour 206 means that the body 102 of the jig 100 is designed and fabricated such that at least a portion of the first jig-surface 104 has a shape, profile, or contour (e.g., curvature) that substantially matches a shape, profile, or contour (e.g., curvature) of at least a portion of the workpiece-surface 204 such that the first jig-surface 104 is configured to make intimate contact with at least a portion of the workpiece-surface 204 during the hole-formation operation.

Referring to FIGS. 4, 12 and 13, the second jig-surface 106 is opposite to the first jig-surface 104. The second jig-surface 106 includes a second jig-surface contour 156. In one or more examples, the second jig-surface 106 is planar. As such, the second jig-surface contour 156 refers to a surface profile of at least a portion of the second jig-surface 106 that is planar or that is otherwise parallel to a virtual (e.g., horizontal) plane. For example, the second jig-surface contour 156 is planar or flat along an X-axis, along a Y-axis, or along the X- and Y-axes.

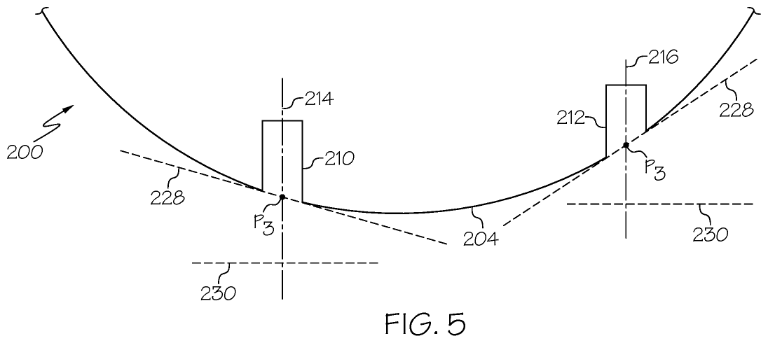

Referring to FIGS. 3-5, 12 and 13, the through holes 108 extend through the body 102, inclusively, between the first jig-surface 104 and the second jig-surface 106 for forming the holes 202 in the workpiece 200. Each one of the through holes 108 includes a through-hole axis 110. In one or more examples, the through-hole axis 110 of each one of the through holes 108 is at least approximately perpendicular to the second jig-surface 106. In one or more examples, the through-hole axis 110 of each one of the through holes 108 is non-perpendicular to the first jig-surface 104. As such, each one of the holes 202 formed in the workpiece 200 has a hole axis 208 that is non-perpendicular to the workpiece-surface 204, as illustrated in FIGS. 3 and 5.

In one or more examples, the through holes 108 include at least two through holes. In an example, the through holes 108 include a first through hole 112 and a second through hole 114. In other examples, the through holes 108 includes more than two through holes.

Referring to FIG. 4, the through-hole axis 110 of each one of the through holes 108 being non-perpendicular to the first jig-surface 104 refers to the through-hole axis 110 being at non-perpendicular to a first virtual plane 158. The first virtual plane 158 is non-orthogonal. For example, the first virtual plane 158 is non-parallel to a horizontal plane and a vertical plane and corresponds to the first jig-surface contour 150 of the first jig-surface 104. As an example, the first virtual plane 158 is tangent to the first jig-surface 104. As an example, the first virtual plane 158 is tangent to the first jig-surface 104 at a point P1. Point P1 is a virtual point in space at which the through-hole axis 110 intersects a profile of the first jig-surface 104. At least a portion of the first jig-surface 104 that includes the through holes 108 lies within the first virtual plane 158.

The example illustrated in FIG. 4 depicts a first instance of the first virtual plane 158 that is tangent to a portion of the first jig-surface 104 at the first through hole 112 and a first through-hole axis 116 of the first through hole 112 is non-perpendicular to the first instance of the first virtual plane 158. The example illustrated in FIG. 4 also depicts a second instance of the first virtual plane 158 that is tangent to a portion of the first jig-surface 104 at the second through hole 114 and a second through-hole axis 118 of the second through hole 114 is non-perpendicular to the second instance of the first virtual plane 158.

Referring still to FIG. 4, the through-hole axis 110 of each one of the through holes 108 being at least approximately perpendicular to the second jig-surface 106 refers to the through-hole axis 110 being at least approximately perpendicular to a second virtual plane 160. The second virtual plane 160 is orthogonal. For example, the second virtual plane 160 is parallel with a horizontal plane or a vertical plane. As an example, the second virtual plane 160 contains point P2. Point P2 is a virtual point in space at which the through-hole axis 110 intersects a profile of the second jig-surface 106. At least a portion of the second jig-surface 106 that includes the through holes 108 lies within the second virtual plane 160.

As illustrated in FIGS. 2, 3, 5 and 13, in one or more examples, the holes 202 are preexisting holes in the workpiece 200 and each have an original diameter. In these examples, the jig 100 enables the holes 202 to be properly reamed to have a desired diameter (e.g., increase the diameter as needed) while maintaining a desired (e.g., original) orientation.

As illustrated in FIGS. 1, 3, 5 and 13, in one or more examples, the workpiece 200 does not initially include preexisting holes. In these examples, the jig 100 enables the holes 202 to be drilled or otherwise formed at a desired location and at a desired orientation.

Referring to FIGS. 1-4, 6, 9, 10 and 13, in one or more examples, the through holes 108 are spaced apart from each other along a longitudinal axis 120 of the body 102. In one or more examples, the though holes 108 are aligned along the longitudinal axis 120 of the body 102. The position of the through holes 108 relative to each other and to the body 102 of the jig 100 is determined or set based on the position of the drilling locations 218 or the holes 202 relative to the workpiece-surface 204 of the workpiece 200.

Referring to FIGS. 1-4, 6, 9, 10 and 13, in one or more examples, the jig 100 includes a first set 124 of bushings 122. The first set 124 of the bushings 122 are located within the through holes 108. In these examples, the bushings 122 line an interior of the through holes 108, thereby protecting an interior hole surface of the body 102 and providing a guide for the cutting tool being used to form (e.g., drill or ream) the holes 202.

Referring to FIGS. 1-4, 6, 9, 10, 12 and 13, in one or more examples, the jig 100 includes a second set 126 of the bushings 122. The second set 126 of the bushings 122 are interchangeable with the first set 124 of the bushings 122. Interchangeability of the bushings 122 of the first set 124 and the second set 126 enable the bushings to be replaced upon wear, thereby protecting the body 102 of the jig 100, without the need to remove the jig 100 from the workpiece 200 and risk losing alignment.

In one or more examples, the bushings 122 of the first set 124 and the bushings 122 of the second set 126 different diameters. As an example, the bushings 122 of the first set 124 have a first diameter 128 and the bushings 122 of the second set 126 have a second diameter 130, which is different than the first diameter 128. Use of and interchangeability of the bushings 122 of the first set 124 and the second set 126 having different diameters enable the jig 100 to be used to form the holes 202 having different diameters without the need to remove the jig 100 from the workpiece 200 and risk losing alignment.

Generally, the diameters of the bushings 122 correspond to or are configured to accommodate the diameter of the rotary cutting tool used to form (e.g., drill or ream) the holes 202 and/or correspond to the desired inner diameter of the holes 202 being formed in the workpiece 200. Interchangeability of the bushings 122 of the first set 124 and the bushings 122 of the second set 126 enable selection and/or modification (e.g., incremental increase) of the diameters of the holes 202 formed in the workpiece 200 without the need to remove the jig 100.

In one or more examples, each one of the bushings 122 is a bushing assembly that includes a liner bushing and an insert bushing. In these examples, the liner bushing is inserted in a through hole in the body 102 and fixed to the body 102. The insert bushing is inserted in and removably coupled to the liner bushing. In these examples, the liner bushings remain in the body 102 and the insert bushings are replaceable upon wear, thereby protecting an interior surface of the liner bushing. In one or more examples, the liner bushings all have the same inner diameter and different sets of the insert bushings have different diameters, thereby enabling the jig 100 to be used to form the holes 202 having different diameters without the need to remove the jig 100 from the workpiece 200 and risk losing alignment.

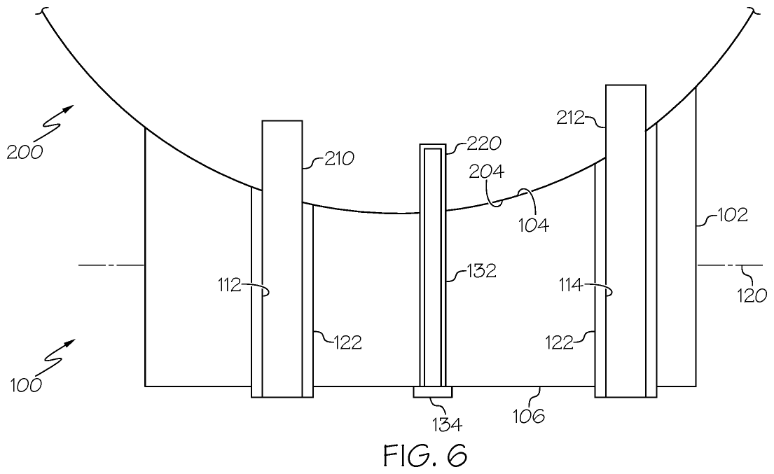

Referring to FIGS. 6-13, in one or more examples, the jig 100 includes a centering hole 132. The centering hole 132 extends through the body 102, inclusively, between the first jig-surface 104 and the second jig-surface 106. The jig 100 also includes a centering pin 134. The centering pin 134 is configured to extend through the centering hole 132 for aligning the jig 100 with the workpiece 200 as desired for forming the holes 202. As an example, the centering pin 134 is configured to extend through the centering hole 132 for aligning the through holes 108 with the workpiece 200.

Referring to FIGS. 6-8 and 11-13, in one or more examples, the workpiece 200 includes a workpiece-centering hole 220 formed through the workpiece-surface 204. The workpiece-centering hole 220 is configured to receive the centering pin 134 during initial positioning and alignment of the jig 100 relative to the workpiece 200. Generally, the position of the centering hole 132 relative to the through holes 108 and to the body 102 of the jig 100 is determined or set based on the position of the workpiece-centering hole 220 relative to the workpiece-surface 204 of the workpiece 200.

Referring to FIGS. 2, 3 and 6, in one or more examples, the jig 100 is aligned with the workpiece 200, for example, using the centering hole 132, the centering pin 134, and the workpiece-centering hole 220, such that the through holes 108 are properly aligned for reaming the holes 202 that exist (e.g., were previously formed) in the workpiece 200.

Referring to FIGS. 1, 3 and 6, in one or more examples, the jig 100 is aligned with the workpiece 200, for example, using the centering hole 132, the centering pin 134, and the workpiece-centering hole 220, such that the through holes 108 are properly aligned with the drilling locations 218 for drilling the holes 202 (e.g., newly formed holes) in the workpiece 200.

Referring to FIGS. 6, 9, 10, 12 and 13, in one or more examples, the through holes 108 are spaced apart from each other along the longitudinal axis 120 of the body 102. In one or more examples, the through holes 108 are aligned along the longitudinal axis 120 of the body 102. The centering hole 132 is located between the through holes 108 along the longitudinal axis 120 of the body 102.

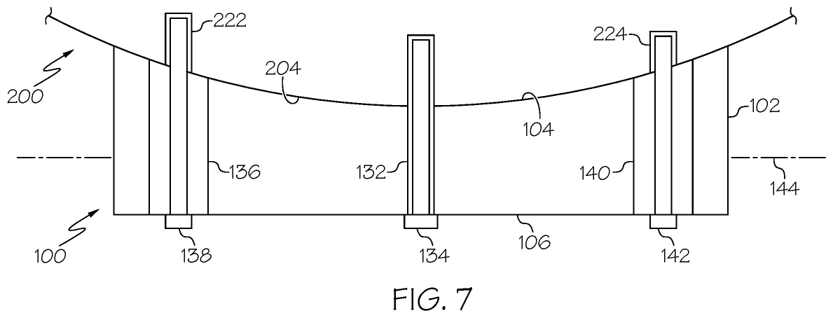

Referring to FIGS. 7-11 and 13, in one or more examples, the jig 100 includes a fastening slot 136. The fastening slot 136 extends through the body 102, inclusively, between the first jig-surface 104 and the second jig-surface 106. The jig 100 includes a slot fastener 138. The slot fastener 138 is configured to extend through the fastening slot 136 for coupling the jig 100 to the workpiece 200. With the slot fastener 138 extending through the fastening slot 136 and coupled (e.g., loosely coupled) to the workpiece 200, the body 102 is linearly movable relative to workpiece 200 and the slot fastener 138.

Referring to FIGS. 7, 8, 11 and 13, in one or more examples, the workpiece 200 includes a workpiece-slot-fastener hole 222 formed through the workpiece-surface 204. The workpiece-slot-fastener hole 222 is configured to receive the slot fastener 138 during positioning and alignment of the jig 100 relative to the workpiece 200. In one or more examples, the slot fastener 138 is configured to be coupled to the workpiece 200 within the workpiece-slot-fastener hole 222. Generally, the position of the slot fastener 138 relative to the through holes 108 and to the body 102 of the jig 100 is determined or set based on the position of the workpiece-slot-fastener hole 222 relative to the workpiece-surface 204 of the workpiece 200. Similarly, the dimensions of the fastening slot 136 (e.g., the length of the slot) are based on the degree of movement needed or desired to properly align the through holes 108 with the drilling locations 218 (e.g., FIG. 1) or the holes 202 (e.g., FIG. 2).

As illustrated in FIGS. 7-11, in one or more examples, the fastening slot 136 is elongated along (e.g., parallel to) a transverse axis 144 of the body 102 that is perpendicular to the longitudinal axis 120. As such, with the slot fastener 138 extending through the fastening slot 136 and loosely (e.g., not fully or tightly) coupled to the workpiece 200, the body 102 is linearly movable along (e.g., parallel to) the transverse axis 144 of the body 102 and relative to workpiece 200 and the slot fastener 138.

In one or more examples (not explicitly illustrated), the fastening slot 136 is elongated along (e.g., parallel to) the longitudinal axis 120 of the body 102. As such, with the slot fastener 138 extending through the fastening slot 136 and loosely (e.g., not fully or tightly) coupled to the workpiece 200, the body 102 is linearly movable along (e.g., parallel to) the longitudinal axis 120 of the body 102 and relative to workpiece 200 and the slot fastener 138.

Referring to FIGS. 7, 10, 11 and 13, in one or more examples, the jig 100 includes a second fastening slot 140. In these examples, the fastening slot 136 may also be referred to as a first fastening slot and the slot fastener 138 may also be referred to as a first slot fastener. The second fastening slot 140 extends through the body 102, inclusively, between the first jig-surface 104 and the second jig-surface 106. The jig 100 also includes a second slot fastener 142. The second slot fastener 142 is configured to extend through the second fastening slot 140 for coupling the jig 100 to the workpiece 200. With the second slot fastener 142 extending through the second fastening slot 140 and coupled to the workpiece 200, the body 102 is linearly movable relative to workpiece 200 and the second slot fastener 142.

Referring to FIGS. 7, 11 and 13, in one or more examples, the workpiece 200 includes a second workpiece-slot-fastener hole 224 formed through the workpiece-surface 204. The second workpiece-slot-fastener hole 224 is configured to receive the second slot fastener 142 during positioning and alignment of the jig 100 relative to the workpiece 200. In one or more examples, the second slot fastener 142 is configured to be coupled to the workpiece 200 within the second workpiece-slot-fastener hole 224. Generally, the position of the second fastening slot 140 relative to the through holes 108 and to the body 102 of the jig 100 is determined or set based on the position of the second workpiece-slot-fastener hole 224 relative to the workpiece-surface 204 of the workpiece 200. Similarly, the dimensions of the second fastening slot 140 (e.g., the length of the slot) are based on the degree of movement needed or desired to properly align the through holes 108 with the drilling locations 218 (e.g., FIG. 1) or the holes 202 (e.g., FIG. 2).

As illustrated in FIGS. 7, 10 and 11, in one or more examples (not illustrated), the second fastening slot 140 is elongated along (e.g., parallel to) the transverse axis 144 of the body 102. As such, with the second slot fastener 142 extending through the second fastening slot 140 and loosely (e.g., not fully or tightly) coupled to the workpiece 200, the body 102 is linearly movable along (e.g., parallel to) the transverse axis 144 of the body 102 and relative to workpiece 200 and the slot fastener 138.

In one or more examples (not explicitly illustrated), the second fastening slot 140 is elongated along (e.g., parallel to) the longitudinal axis 120 of the body 102. As such, with the second slot fastener 142 extending through the second fastening slot 140 and loosely (e.g., not fully or tightly) coupled to the workpiece 200, the body 102 is linearly movable along (e.g., parallel to) the longitudinal axis 120 of the body 102 and relative to workpiece 200 and the second slot fastener 142.

Referring to FIGS. 7, 10, 11 and 13, in one or more examples, the fastening slot 136 and the second fastening slot 140 are spaced apart from each other along the transverse axis 144 of the body 102. In one or more examples, the fastening slot 136 and the second fastening slot 140 are aligned along the transverse axis 144 of the body 102.

In one or more examples (not explicitly illustrated), the fastening slot 136 and the second fastening slot 140 are spaced apart from each other along the longitudinal axis 120 of the body 102. In one or more examples, the fastening slot 136 and the second fastening slot 140 are aligned along the longitudinal axis 120 of the body 102.

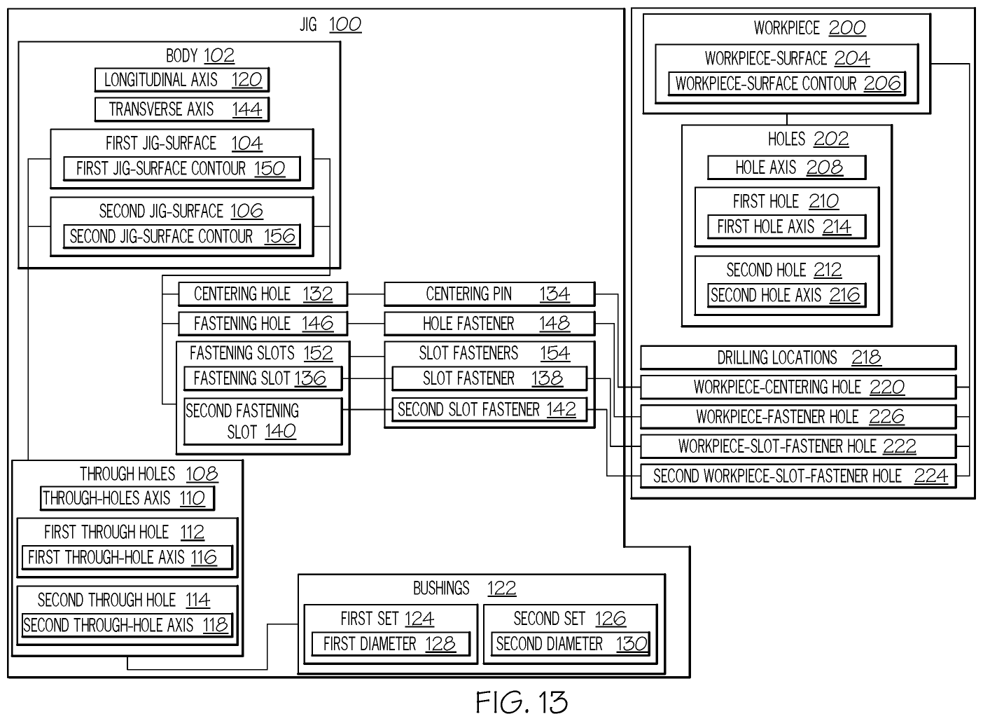

In other examples, the jig 100 can include any number of fastening slots 152 and number of slot fasteners 154 (FIG. 13). In these examples, the workpiece 200 also includes any number of workpiece-slot-fastener holes that correspond to the fastening slots 152 of the jig 100. In one or more examples one or more of the fastening slots 152 may extend along the longitudinal axis 120 and one or more of the fastening slots 152 may extend along the transverse axis 144 such that the body 102 is linearly movable along (e.g., parallel to) the longitudinal axis 120 and the transverse axis 144 and relative to workpiece 200 while loosely coupled to the workpiece 200 by the slot fasteners 154.

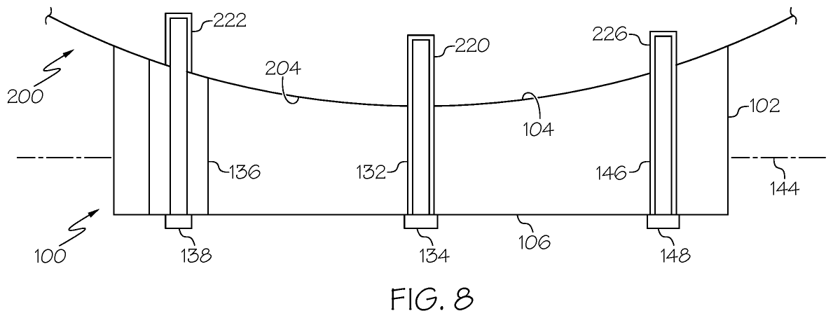

Referring to FIGS. 8, 9 and 13, in one or more examples, the jig 100 includes a fastening hole 146. The fastening hole 146 extends through the body 102, inclusively, between the first jig-surface 104 and the second jig-surface 106. The jig 100 also includes a hole fastener 148. The hole fastener 148 is configured to extend through the fastening hole 146 for coupling the jig 100 to the workpiece 200.

Referring to FIGS. 8 and 13, in one or more examples, the workpiece 200 includes a workpiece-fastener hole 226 formed through the workpiece-surface 204. The workpiece-fastener hole 226 is configured to receive the hole fastener 148 during coupling or attachment of the jig 100 to the workpiece 200. In one or more examples, the hole fastener 148 is configured to be coupled to the workpiece 200 within the workpiece-fastener hole 226. Generally, the position of the fastening hole 146 relative to the through holes 108 and to the body 102 of the jig 100 is determined or set based on the position of the workpiece-fastener hole 226 relative to the workpiece-surface 204 of the workpiece 200.

Referring to FIGS. 8, 9 and 13, in one or more examples, the fastening slot 136 and the fastening hole 146 are spaced apart from each other along the transverse axis 144 of the body 102. In one or more examples, the fastening slot 136 and the fastening hole 146 are aligned along the transverse axis 144 of the body 102.

Referring again to FIGS. 1-13, disclosed are additional examples of the jig 100 and, more particularly, the jig 100 configured for reaming the holes 202 in the workpiece 200. The following are examples of the jig 100, according to the present disclosure. The examples of the jig 100, described herein below and illustrated in FIGS. 1-13, include a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIGS. 1-4, 6-10, 12 and 13, in one or more examples, the jig 100 includes the body 102. The body 102 includes the first jig-surface 104 and the second jig-surface 106. The first jig-surface 104 includes comprises the first jig-surface contour 150, wherein the first jig-surface contour 150 is complementary to the workpiece-surface contour 206 of the workpiece-surface 204. The second jig-surface 106 is planar and is opposite to the first jig-surface 104. The jig 100 includes a first through hole 112 that extends through the body 102, inclusively, between the first jig-surface 104 and the second jig-surface 106 for reaming a first hole 210 in the workpiece 200. The jig 100 includes a second through hole 114 that extends through the body 102, inclusively, between the first jig-surface 104 and the second jig-surface 106 for reaming a second hole 212 in the workpiece 200. The first through hole 112 includes a first through-hole axis 116 that is perpendicular to the second jig-surface 106 and that is non-perpendicular to the first jig-surface 104 such that the first through-hole axis 116 and a first hole axis 214 of the first hole 210 are coincident or parallel to each other. The second through hole 114 includes a second through-hole axis 118 that is perpendicular to the second jig-surface 106 and that is non-perpendicular to the first jig-surface 104 such that the second through-hole axis 118 and a second hole axis 216 of the second hole 212 are coincident or parallel to each other.

In these examples, the first through hole 112 and the second through hole 114 are particular examples of the through holes 108. In these examples, the first hole 210 and the second hole 212 are specific examples of the holes 202 in the workpiece 200.

In one or more examples, the first hole 210 and the second hole 212 are preexisting holes in the workpiece 200 and each have an original diameter. In these examples, the jig 100 enables the first hole 210 and the second hole 212 to be properly reamed to have a desired diameter (e.g., increase the diameter as needed) while maintaining a desired (e.g., original) orientation.

Referring to FIGS. 1-4, 6, 9, 10, 12 and 13, in one or more examples, the first through hole 112 and the second through hole 114 are spaced apart from each other along the longitudinal axis 120 of the body 102. In one or more examples, the first through hole 112 and the second through hole 114 are aligned along the longitudinal axis 120 of the body 102.

Referring to FIGS. 1-4, 6, 9, 10, 12 and 13, in one or more examples, the jig 100 includes the first set 124 of bushings 122. One of the bushings 122 of the first set 124 is located within each one of the first through hole 112 and the second through hole 114. As an example, a first one of the bushings 122 is located within the first through hole 112 and a second one of the bushings 122 is located within the second through hole 114.

Referring to FIGS. 1-4, 6, 9, 10, 12 and 13, in one or more examples, the jig 100 includes the second set 126 of the bushings 122. The second set 126 of the bushings 122 are interchangeable with the first set 124 of the bushings 122. The bushings 122 of the first set 124 and the bushings 122 of the second set 126 have different diameters.

Referring to FIGS. 6-13, in one or more examples, the jig 100 includes the centering hole 132. The centering hole 132 extends through the body 102, inclusively, between the first jig-surface 104 and the second jig-surface 106. The jig 100 includes the centering pin 134. The centering pin 134 is configured to extend through the centering hole 132 for aligning the through holes 108 with the workpiece 200.

Referring to FIGS. 6, 9, 10, 11 and 13, in one or more examples, the first through hole 112 and the second through hole 114 are spaced apart from each other along the longitudinal axis 120 of the body 102. In one or more examples, the first through hole 112 and the second through hole 114 are aligned along the longitudinal axis 120 of the body 102. The centering hole 132 is located between the first through hole 112 and the second through hole 114 along the longitudinal axis 120 of the body 102.

Referring to FIGS. 7-13, in one or more examples, the jig 100 includes the fastening slot 136. The fastening slot 136 extends through the body 102, inclusively, between the first jig-surface 104 and the second jig-surface 106. The jig 100 includes the slot fastener 138. The slot fastener 138 extends through the fastening slot 136 for coupling to the workpiece 200. With the slot fastener 138 extending through the fastening slot 136 and loosely coupled to the workpiece 200, the body 102 is linearly movable relative to workpiece 200 and the slot fastener 138.

Referring to FIGS. 7 and 10-13, in one or more examples, the jig 100 includes the second fastening slot 140. The second fastening slot 140 extends through the body 102, inclusively, between the first jig-surface 104 and the second jig-surface 106. The jig 100 includes the second slot fastener 142 that extends through the second fastening slot 140 for coupling to the workpiece 200. With the second slot fastener 142 extending through the second fastening slot 140 and loosely coupled to the workpiece 200, the body 102 is linearly movable relative to workpiece 200 and the second slot fastener 142.

Referring to FIGS. 7 and 10-13, in one or more examples, the fastening slot 136 and the second fastening slot 140 are spaced apart from each other along the transverse axis 144 of the body 102. In one or more examples, the fastening slot 136 and the second fastening slot 140 are aligned along the transverse axis 144 of the body 102.

In one or more examples (not explicitly illustrated), the fastening slot 136 and the second fastening slot 140 are spaced apart from each other aligned along the longitudinal axis 120 of the body 102. In one or more examples, the fastening slot 136 and the second fastening slot 140 are aligned along the longitudinal axis 120 of the body 102.

Referring to FIGS. 8, 9 and 13, in one or more examples, the jig 100 includes the fastening hole 146. The fastening hole 146 extends through the body 102, inclusively, between the first jig-surface 104 and the second jig-surface 106. The jig 100 includes the hole fastener 148. The hole fastener 148 extends through the fastening hole 146 for coupling to the workpiece 200.

Referring to FIGS. 8, 9 and 13, in one or more examples, the fastening slot 136 and the fastening hole 146 are spaced apart from each other along the transverse axis 144 of the body 102. In one or more examples, the fastening slot 136 and the fastening hole 146 are aligned along the transverse axis 144 of the body 102.

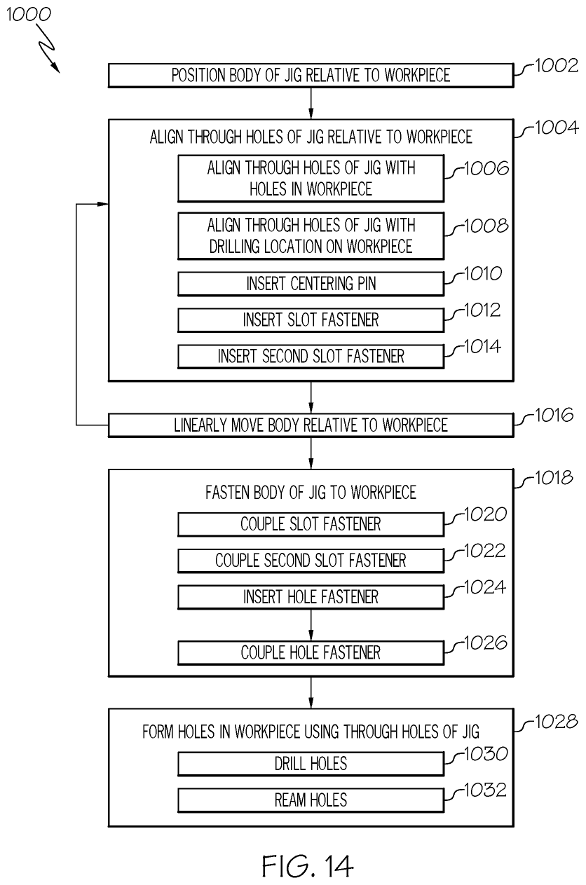

Referring generally to FIGS. 1-13 and particularly to FIG. 14, disclosed are examples of the method 1000. In one or more examples, the method 1000 is implemented using the jig 100 (FIG. 1-13). The following are examples of the method 1000, according to the present disclosure. The examples of the method 1000, described herein below and illustrated in FIG. 14, include a number of elements, steps, and/or operations. Not all of the elements, steps, and/or operations described or illustrated in one example are required in that example. Some or all of the elements, steps, and/or operations described or illustrated in one example can be combined with other examples in various ways without the need to include other elements, steps, and/or operations described in those other examples, even though such combination or combinations are not explicitly described or illustrated by example herein.

In one or more examples, the method 1000 includes a step of (block 1002) positioning the body 102 of the jig 100 relative to the workpiece 200. The jig 100 is positioned such that the first jig-surface 104 is in contact with the workpiece-surface 204. The first jig-surface contour 150 of the first jig-surface 104 is complementary to the workpiece-surface contour 206 of the workpiece-surface 204.

In one or more examples, the method 1000 includes a step of (block 1004) aligning the through holes 108 of the jig 100 with the workpiece 200. The step of (block 1004) aligning can be performed by one or more of or a combination of the below-described steps.

In one or more examples, according to the method 1000, the step of (block 1004) aligning the through holes 108 includes a step of (block 1006) aligning the through holes 108 with the holes 202 in the workpiece 200 such that the through-hole axis 110 of each one of the through holes 108 is non-parallel with the workpiece-surface 204 and the hole axis 208 of each one of the holes 202 is coincident or parallel to the through-hole axis 110 of a corresponding one of the through holes 108.

In one or more examples, according to the method 1000, the step of (block 1004) aligning the through holes 108 includes a step of (block 1008) aligning the through holes 108 with drilling locations 218 on the workpiece 200 such that the through-hole axis 110 of each one of the through holes 108 is non-parallel with the workpiece-surface 204.

In one or more examples, the method 1000, such as the aligning step (e.g., block 1004), includes a step of (block 1010) inserting a centering pin 134 through the centering hole 132 that extends through the body 102, inclusively, between the first jig-surface 104 and the second jig-surface 106. In one or more examples, the method 1000 also includes a step of coupling the centering pin 134 to the workpiece 200. As an example, the step of (block 1004) aligning the through holes 108 is performed or achieved using the centering pin 134 inserted through the centering hole 132 and inserted in and, optionally, coupled to, the workpiece-centering hole 220 (e.g., a hole in the workpiece 200 that corresponds to the centering hole 132 of the jig 100).

Generally, the step of (block 1010) inserting the centering pin 134 through the centering hole 132 and the workpiece-centering holes 220 at least approximately coaxially aligns the centering hole 132 and the workpiece-centering hole 220. In one or more examples, the step of (block 1010) inserting the centering pin 134 through the centering hole 132 and the workpiece-centering holes 220 achieves an initial or rough alignment of the through holes 108. In one or more examples, the step of (block 1010) inserting the centering pin 134 through the centering hole 132 achieves a fine alignment of the through holes 108.

In one or more examples, the method 1000, such as the aligning step (e.g., block 1004), includes a step of (block 1012) inserting the slot fastener 138 through the fastening slot 136 that extends through the body 102, inclusively, between the first jig-surface 104 and the second jig-surface 106. As an example, the step of (block 1004) aligning the through holes 108 is performed or achieved using the slot fastener 138 as inserted through the fastening slot 136 and inserted in and, optionally, loosely coupled to, the workpiece-slot-fastener hole 222 (e.g., a hole in the workpiece 200 that corresponds to the fastening slot 136 of the jig 100).

Generally, the step of (block 1012) inserting the slot fastener 138 through the fastening slot 136 and the workpiece-slot-fastener hole 222 aligns the fastening slot 136 and the workpiece-slot-fastener hole 222. In one or more examples, the step of (block 1012) inserting the slot fastener 138 through the fastening slot 136 and the workpiece-slot-fastener hole 222 enables position adjustment of the jig 100 relative to the workpiece 200 to achieve finer alignment of the through holes 108.

In one or more examples, the method 1000, such as the aligning step (e.g., block 1004), includes a step of (block 1014) inserting the second slot fastener 142 through the second fastening slot 140 that extends through the body 102, inclusively, between the first jig-surface 104 and the second jig-surface 106. As an example, the step of (block 1004) aligning the through holes 108 is additionally performed or further achieved using the second slot fastener 142 as inserted through the second fastening slot 140 and inserted in and, optionally, loosely coupled to, the second workpiece-slot-fastener hole 224 (e.g., a hole in the workpiece 200 that corresponds to the second fastening slot 140 of the jig 100).

Generally, the step of (block 1014) inserting the second slot fastener 142 through the second fastening slot 140 and the second workpiece-slot-fastener hole 224 aligns the second fastening slot 140 and the second workpiece-slot-fastener hole 224. In one or more examples, the step of (block 1014) inserting the second slot fastener 142 through the second fastening slot 140 and the second workpiece-slot-fastener hole 224 enables position adjustment of the jig 100 relative to the workpiece 200 to achieve finer alignment of the through holes 108.

In one or more examples, the method 1000 includes a step of (block 1016) linearly moving the body 102 relative to the workpiece 200. In one or more examples, the body 102 also linearly moves relative to the slot fastener 138 that is inserted through an aligned pair of the fastening slot 136 and the workpiece-slot-fastener hole 222 and loosely coupled to the workpiece 200 in the workpiece-slot-fastener hole 222. In one or more examples, the body 102 also linearly moves relative to the second slot fastener 142 that is inserted through an aligned pair of the second fastening slot 140 and the second workpiece-slot-fastener hole 224 and loosely coupled to the workpiece 200 in the second workpiece-slot-fastener hole 224. In one or more examples, the step of (block 1016) linearly moving the body 102 relative to the workpiece 200 forms a portion of the positioning step (e.g., block 1002) or enables repositioning of the body 102 of the jig 100 for more fine alignment of the through holes 108 (e.g., block 1004).

In one or more examples, the method 1000 includes a step of (block 1018) fastening the body 102 to the workpiece 200. The step of (block 1018) fastening can be performed by one or more of or a combination of the below-described steps.

In one or more examples, according to the method 1000, the step of (block 1018) fastening includes a step of (block 1020) coupling the slot fastener 138 to the workpiece 200. As an example, the step of (block 1018) fastening the body 102 to the workpiece 200 is performed or achieved using the slot fastener 138 as inserted through the fastening slot 136 and the workpiece-slot-fastener hole 222 and coupled (e.g., completely or tightly) to the workpiece 200.

In one or more examples, according to the method 1000, the step of (block 1018) fastening includes a step of (block 1022) coupling the second slot fastener 142 to the workpiece 200. As an example, the step of (block 1018) fastening the body 102 to the workpiece 200 is performed or achieved using the second slot fastener 142 as inserted through the second fastening slot 140 and the second workpiece-slot-fastener hole 224 and coupled (e.g., completely or tightly) to the workpiece 200.

In one or more examples, according to the method 1000, the step of (block 1018) fastening the body 102 to the workpiece 200 includes a step of (block 1024) inserting the hole fastener 148 through the fastening hole 146 that extends through the body 102, inclusively, between the first jig-surface 104 and the second jig-surface 106 and a step of (block 1026) coupling the hole fastener 148 to the workpiece 200. As an example, the step of (block 1018) fastening the body 102 to the workpiece 200 is performed or at least partially achieved using the hole fastener 148 as inserted through the fastening hole 146 and the workpiece-fastener hole 226 (e.g., a hole in the workpiece 200 that corresponds to the fastening hole 146 of the jig 100) and coupled (e.g., completely or tightly) to the workpiece 200.

In one or more examples, the method 1000 includes a step of (block 1028) forming the holes 202 in the workpiece 200 using the through holes 108 that extend through the body 102, inclusively, between the first jig-surface 104 and the second jig-surface 106. Each one of the through holes 108 includes the through-hole axis 110 that is perpendicular to the second jig-surface 106 and that is non-perpendicular to the first jig-surface 104 such that each one of the holes 202 formed in the workpiece 200 has the hole axis 208 that is non-perpendicular to the workpiece-surface 204.

Referring to FIG. 5, the hole axis 208 of each one of the holes 202 being non-perpendicular to the workpiece-surface 204 refers to the hole axis 208 being at non-perpendicular to a third virtual plane 228. The third virtual plane 228 is non-orthogonal. For example, the third virtual plane 228 is non-parallel to a horizontal plane (e.g., a fourth virtual plane 230) and a vertical plane and corresponds to the workpiece-surface contour 206 of the workpiece-surface 204. As an example, the third virtual plane 228 is tangent to the workpiece-surface 204. As an example, the third virtual plane 228 is tangent to the workpiece-surface 204 at a point P3. Point P3 is a virtual point in space at which the hole axis 208 intersects a profile of the workpiece-surface 204. At least a portion of the workpiece-surface 204 that includes the holes 202 lies within the third virtual plane 228. In one or more examples, the hole axis 208 of each one of the holes 202 is at least approximately perpendicular to the fourth virtual plane 230. Generally, the second jig-surface 106, the second virtual plane 160, and the fourth virtual plane 230 are parallel to each other.

The example illustrated in FIG. 5 depicts a first instance of the third virtual plane 228 that is tangent to a portion of the workpiece-surface 204 at the first hole 210 and a first hole axis 214 of the first hole 210 is non-perpendicular to the first instance of the third virtual plane 228. The example illustrated in FIG. 5 also depicts a second instance of the third virtual plane 228 that is tangent to a portion of the workpiece-surface 204 at the second hole 212 and a second hole axis 216 of the second hole 212 is non-perpendicular to the second instance of the third virtual plane 228.

In one or more examples, according to the method 1000, the step of (block 1028) forming the holes 202 includes a step of (block 1030) drilling the holes 202. Drilling the holes 202 produces new holes in the workpiece 200 at desired instances of the drilling locations 218 on the workpiece 200 such that the holes 202 have a desired orientation relative to the workpiece-surface 204, for example, in which the hole axis 208 of each one of the holes 202 is non-perpendicular to the workpiece-surface 204.

In one or more examples, according to the method 1000, the step of (block 1028) forming the holes 202 includes a step of (block 1032) reaming the holes 202. Reaming the holes 202 modifies the diameter of preexisting holes in the workpiece 200 such that the holes 202 maintain a desired orientation relative to the workpiece-surface 204, for example, in which the hole axis 208 of each one of the holes 202 is non-perpendicular to the workpiece-surface 204.

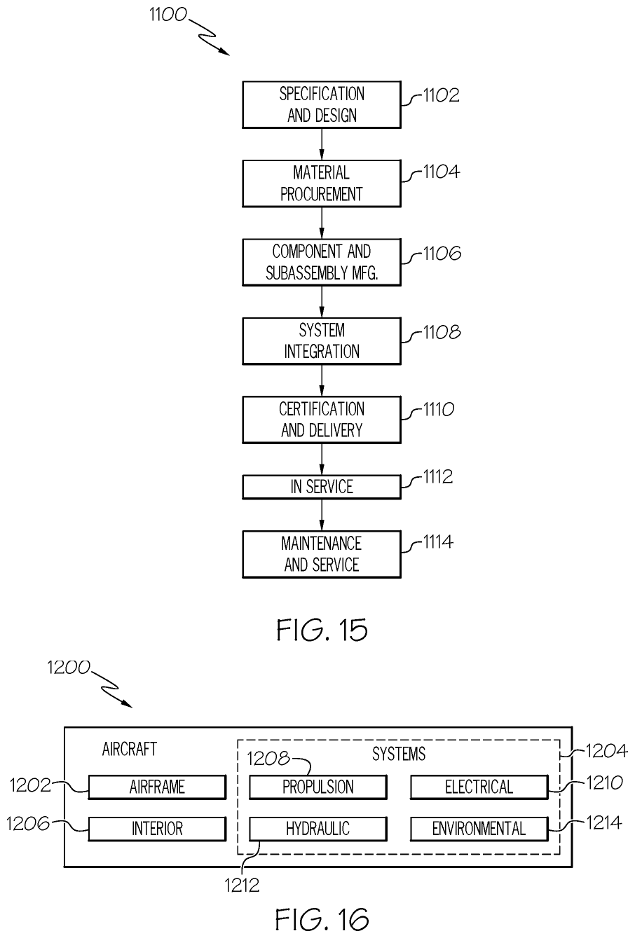

Referring now to FIGS. 15 and 16, examples of the jig 100 and the method 1000 described herein, may be related to, or used in the context of, the aircraft manufacturing and service method 1100, as shown in the flow diagram of FIG. 15 and the aircraft 1200, as schematically illustrated in FIG. 16. As an example, the aircraft 1200 and/or the aircraft production and service method 1100 may include or utilize holes formed using the jig 100 and/or according to the method 1000.

Referring to FIG. 16, which illustrates an example of the aircraft 1200. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems, such as, but not limited to, communications systems, avionics systems, software distribution systems, network communications systems, passenger information/entertainment systems, guidance systems, radar systems, weapons systems, and the like. The aircraft 1200 can have any number of components that includes holes formed (e.g., drilled or reamed) using the jig 100 and/or according to the method 1000.

Referring to FIG. 15, during pre-production of the aircraft 1200, the manufacturing and service method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the manufacturing and service method 1100 illustrated in FIG. 15 may be performed or carried out by a system integrator, a third party, and/or an operator (e.g., a customer). For the purposes of this description, a system integrator may include, without limitation, any number of spacecraft manufacturers and major-system subcontractors; a third party may include, without limitation, any number of vendors, subcontractors, and suppliers; and an operator may be an airline, leasing company, military entity, service organization, and so on.

Examples of the jig 100 and the method 1000 shown and described herein, may be employed during any one or more of the stages of the manufacturing and service method 1100 shown in the flow diagram illustrated by FIG. 15. In an example, components of the aircraft 1200 can include holes that are formed using the jig 100 and/or according to the method 1000 during a portion of component and subassembly manufacturing (block 1106) and/or system integration (block 1108). Further, holes in components can be formed using the jig 100 and/or according to the method 1000 while the aircraft 1200 is in service (block 1112). Also, holes in components can be formed using the jig 100 and/or according to the method 1000 during system integration (block 1108) and certification and delivery (block 1110). Similarly, holes in components can be formed using the jig 100 and/or according to the method 1000 while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, one or more items being along an axis, such as one or more elements, components, or features being spaced apart long an axis, aligned along an axis, extending along an axis, and similar language refers to the one or more items being parallel to or coincident with the axis.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1-13 and 16, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-13 and 16, referred to above, need be included in every example and not all elements, features, and/or components described herein are necessarily depicted in each illustrative example. Accordingly, some of the elements, features, and/or components described and illustrated in FIGS. 1-13 and 16 may be combined in various ways without the need to include other features described and illustrated in FIGS. 1-13 and 16, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-13 and 16, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-13 and 16, and such elements, features, and/or components may not be discussed in detail herein with reference to each of FIGS. 1-13 and 16. Similarly, all elements, features, and/or components may not be labeled in each of FIGS. 1-13 and 16, but reference numerals associated therewith may be utilized herein for consistency.

In FIGS. 14 and 15, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 14 and 15 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, the disclosure comprises examples (embodiments) according to the following clauses:

Clause 1. A jig for forming holes in a workpiece, wherein the workpiece comprises a workpiece-surface having a workpiece-surface contour and wherein the jig comprises: a body comprising: a first jig-surface that comprises a first jig-surface contour, wherein the first jig-surface contour is complementary to the workpiece-surface contour of the workpiece-surface; and a second jig-surface that is planar and that is opposite to first jig-surface; and through holes that extend through the body between the first jig-surface and the second jig-surface for forming the holes in the workpiece, wherein each one of the through holes comprises a through-hole axis that is perpendicular to the second jig-surface and that is non-perpendicular to the first jig-surface such that each one of the holes formed in the workpiece has a hole axis that is non-perpendicular to the workpiece-surface.

Clause 2. The jig of Clause 1, wherein the through holes are spaced apart from each other and aligned along a longitudinal axis of the body.

Clause 3. The jig of Clause 1 or 2, further comprising a first set of bushings that are located within the through holes.

Clause 4. The jig of Clause 3, further comprising a second set of the bushings that are interchangeable with the first set of the bushings, wherein the bushings of the first set and the bushings of the second set have different diameters.

Clause 5. The jig of any of Clauses 1-4, further comprising: a centering hole that extends through the body between the first jig-surface and the second jig-surface; and a centering pin that extends through the centering hole for aligning the through holes with the workpiece.

Clause 6. The jig of Clause 5, wherein: the through holes are spaced apart from each other and aligned along a longitudinal axis of the body; and the centering hole is located between through holes along the longitudinal axis of the body.

Clause 7. The jig of any of Clauses 1-6, further comprising: a fastening slot that extends through the body between the first jig-surface and the second jig-surface; and a slot fastener that extends through the fastening slot for coupling to the workpiece, wherein, with the slot fastener extending through the fastening slot, the body is linearly movable relative to workpiece and the slot fastener.

Clause 8. The jig of Clause 7, further comprising: a second fastening slot that extends through the body between the first jig-surface and the second jig-surface; and a second slot fastener that extends through the second fastening slot for coupling to the workpiece, wherein: the fastening slot and the second fastening slot are spaced apart from each other and aligned along a transverse axis of the body; and with the second slot fastener extending through the second fastening slot, the body is linearly movable relative to workpiece and the second slot fastener.

Clause 9. The jig of Clause 7, further comprising: a fastening hole that extends through the body between the first jig-surface and the second jig-surface; and a hole fastener that extends through the fastening hole for coupling to the workpiece, wherein the fastening slot and the fastening hole are spaced apart from each other and aligned along a transverse axis of the body.

Clause 10. A jig for reaming holes in a workpiece, wherein the workpiece is annular and comprises a workpiece-surface having a workpiece-surface contour and wherein the jig comprises: a body comprising: a first jig-surface that comprises a first jig-surface contour, wherein the first jig-surface contour is complementary to the workpiece-surface contour of the workpiece-surface; and a second jig-surface that is planar and that is opposite to first jig-surface; a first through hole that extends through the body between the first jig-surface and the second jig-surface for reaming a first hole in the workpiece; and a second through hole that extends through the body between the first jig-surface and the second jig-surface for reaming a second hole in the workpiece, wherein: the first through hole comprises a first through-hole axis that is perpendicular to the second jig-surface and that is non-perpendicular to the first jig-surface such that the first through-hole axis and a first hole axis of the first hole are coincident or parallel to each other; and the second through hole comprises a second through-hole axis that is perpendicular to the second jig-surface and that is non-perpendicular to the first jig-surface such that the second through-hole axis and a second hole axis of the second hole are coincident or parallel to each other.

Clause 11. The jig of Clause 10, wherein the first through hole and the second through hole are spaced apart from each other and aligned along a longitudinal axis of the body.

Clause 12. The jig of Clause 10 or 11, further comprising: a first set of bushings; and a second set of the bushings, wherein: one of the bushings of the first set or the second set is located within each one of the first through hole and the second through hole; the second set of the bushings are interchangeable with the first set of the bushings; and the bushings of the first set and the bushings of the second set have different diameters.

Clause 13. The jig of any of Clauses 10-12, further comprising: a centering hole that extends through the body between the first jig-surface and the second jig-surface; and a centering pin that extends through the centering hole for aligning the through holes with the workpiece, wherein: the first through hole and the second through hole are spaced apart from each other and aligned along a longitudinal axis of the body; and the centering hole is located between the first through hole and the second through hole along the longitudinal axis of the body.

Clause 14. The jig of any of Clauses 10-13, further comprising: a fastening slot that extends through the body between the first jig-surface and the second jig-surface; and a slot fastener that extends through the fastening slot for coupling to the workpiece, wherein, with the slot fastener extending through the fastening slot and coupled to the workpiece, the body is linearly movable relative to workpiece and the slot fastener.

Clause 15. The jig of Clause 14, further comprising: a second fastening slot that extends through the body between the first jig-surface and the second jig-surface; and a second slot fastener that extends through the second fastening slot for coupling to the workpiece, wherein the fastening slot and the second fastening slot are spaced apart from each other and aligned along a transverse axis of the body; and with the second slot fastener extending through the second fastening slot and coupled to the workpiece, the body is linearly movable relative to workpiece and the second slot fastener.

Clause 16. The jig of Clause 14 or 15, further comprising: a fastening hole that extends through the body between the first jig-surface and the second jig-surface; and a hole fastener that extends through the fastening hole for coupling to the workpiece, wherein: the fastening slot and the fastening hole are spaced apart from each other and aligned along a transverse axis of the body; and with the slot fastener extending through the fastening slot and coupled to the workpiece, the body is linearly movable relative to workpiece and the slot fastener.

Clause 17. A method for forming holes in a workpiece, wherein the workpiece comprises a workpiece-surface having a workpiece-surface contour, and wherein the method comprises: positioning a body of a jig relative to the workpiece such that a first jig-surface is in contact with the workpiece surface, wherein a first jig-surface contour of the first jig-surface is complementary to a workpiece-surface contour of the workpiece-surface; and forming the holes in the workpiece using through holes that extend through the body between the first jig-surface and a second jig-surface, wherein each one of the through holes comprises a through-hole axis that is perpendicular to the second jig-surface and that is non-perpendicular to the first jig-surface such that each one of the holes formed in the workpiece has a hole axis that is non-perpendicular to the workpiece-surface.

Clause 18. The method of Clause 17, wherein forming the holes comprises one of drilling the holes or reaming the holes.

Clause 19. The method of Clause 17 or 18, further comprising aligning the through holes with the holes in the workpiece such that the through-hole axis of each one of the through holes is non-perpendicular to the workpiece-surface and is coincident or parallel to the hole axis of each one of the holes.

Clause 20. The method of any of Clauses 17-19, further comprising aligning the through holes with drilling locations on the workpiece such that the through-hole axis of each one of the through holes is non-perpendicular to the workpiece-surface.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the jig 100 and the method 1000 have been shown and described, modifications may occur to those skilled in the art upon reading the specification. The present application includes such modifications and is limited only by the scope of the claims.

What is claimed is:

1. A jig for forming holes in a workpiece, wherein the workpiece comprises a workpiece-surface having a workpiece-surface contour and wherein the jig comprises:
a body comprising:
a first jig-surface that comprises a first jig-surface contour, wherein the first jig-surface contour is complementary to the workpiece-surface contour of the workpiece-surface; and
a second jig-surface that is planar and that is opposite to first jig-surface; and
through holes that extend through the body between the first jig-surface and the second jig-surface for forming the holes in the workpiece, wherein each one of the through holes comprises a through-hole axis that is perpendicular to the second jig-surface and that is non-perpendicular to the first jig-surface such that each one of the holes formed in the workpiece has a hole axis that is non-perpendicular to the workpiece-surface.

2. The jig of claim 1, wherein the through holes are spaced apart from each other and aligned along a longitudinal axis of the body.

3. The jig of claim 1, further comprising a first set of bushings that are located within the through holes.

4. The jig of claim 3, further comprising a second set of the bushings that are interchangeable with the first set of the bushings,
wherein the bushings of the first set and the bushings of the second set have different diameters.

5. The jig of claim 1, further comprising:
a centering hole that extends through the body between the first jig-surface and the second jig-surface; and
a centering pin that extends through the centering hole for aligning the through holes with the workpiece.

6. The jig of claim 5, wherein:
the through holes are spaced apart from each other and aligned along a longitudinal axis of the body; and
the centering hole is located between through holes along the longitudinal axis of the body.

7. The jig of claim 1, further comprising:
a fastening slot that extends through the body between the first jig-surface and the second jig-surface; and
a slot fastener that extends through the fastening slot for coupling to the workpiece,
wherein, with the slot fastener extending through the fastening slot, the body is linearly movable relative to workpiece and the slot fastener.

8. The jig of claim 7, further comprising:
a second fastening slot that extends through the body between the first jig-surface and the second jig-surface; and
a second slot fastener that extends through the second fastening slot for coupling to the workpiece,
wherein:
the fastening slot and the second fastening slot are spaced apart from each other and aligned along a transverse axis of the body; and
with the second slot fastener extending through the second fastening slot, the body is linearly movable relative to workpiece and the second slot fastener.

9. The jig of claim 7, further comprising:
a fastening hole that extends through the body between the first jig-surface and the second jig-surface; and
a hole fastener that extends through the fastening hole for coupling to the workpiece,
wherein the fastening slot and the fastening hole are spaced apart from each other and aligned along a transverse axis of the body.

10. A jig for reaming holes in a workpiece, wherein the workpiece is annular and comprises a workpiece-surface having a workpiece-surface contour and wherein the jig comprises:
a body comprising:
a first jig-surface that comprises a first jig-surface contour, wherein the first jig-surface contour is complementary to the workpiece-surface contour of the workpiece-surface; and
a second jig-surface that is planar and that is opposite to first jig-surface;
a first through hole that extends through the body between the first jig-surface and the second jig-surface for reaming a first hole in the workpiece; and
a second through hole that extends through the body between the first jig-surface and the second jig-surface for reaming a second hole in the workpiece,
wherein:
the first through hole comprises a first through-hole axis that is perpendicular to the second jig-surface and that is non-perpendicular to the first jig-surface such that the first through-hole axis and a first hole axis of the first hole are coincident or parallel to each other; and
the second through hole comprises a second through-hole axis that is perpendicular to the second jig-surface and that is non-perpendicular to the first jig-surface such that the second through-hole axis and a second hole axis of the second hole are coincident or parallel to each other.

11. The jig of claim 10, wherein the first through hole and the second through hole are spaced apart from each other and aligned along a longitudinal axis of the body.

12. The jig of claim 10, further comprising:
a first set of bushings; and
a second set of the bushings,
wherein:
one of the bushings of the first set or the second set is located within each one of the first through hole and the second through hole;
the second set of the bushings are interchangeable with the first set of the bushings; and
the bushings of the first set and the bushings of the second set have different diameters.

13. The jig of claim 10, further comprising:
a centering hole that extends through the body between the first jig-surface and the second jig-surface; and
a centering pin that extends through the centering hole for aligning the through holes with the workpiece,
wherein:
the first through hole and the second through hole are spaced apart from each other and aligned along a longitudinal axis of the body; and
the centering hole is located between the first through hole and the second through hole along the longitudinal axis of the body.

14. The jig of claim 10, further comprising:
a fastening slot that extends through the body between the first jig-surface and the second jig-surface; and
a slot fastener that extends through the fastening slot for coupling to the workpiece,
wherein, with the slot fastener extending through the fastening slot and coupled to the workpiece, the body is linearly movable relative to workpiece and the slot fastener.

15. The jig of claim 14, further comprising:
a second fastening slot that extends through the body between the first jig-surface and the second jig-surface; and
a second slot fastener that extends through the second fastening slot for coupling to the workpiece,
wherein
the fastening slot and the second fastening slot are spaced apart from each other and aligned along a transverse axis of the body; and
with the second slot fastener extending through the second fastening slot and coupled to the workpiece, the body is linearly movable relative to workpiece and the second slot fastener.

16. The jig of claim 14, further comprising:
a fastening hole that extends through the body between the first jig-surface and the second jig-surface; and
a hole fastener that extends through the fastening hole for coupling to the workpiece,
wherein:
the fastening slot and the fastening hole are spaced apart from each other and aligned along a transverse axis of the body; and
with the slot fastener extending through the fastening slot and coupled to the workpiece, the body is linearly movable relative to workpiece and the slot fastener.

17. A method for forming holes in a workpiece, wherein the workpiece comprises a workpiece-surface having a workpiece-surface contour, and wherein the method comprises:
positioning a body of a jig relative to the workpiece such that a first jig-surface is in contact with the workpiece surface, wherein a first jig-surface contour of the first jig-surface is complementary to a workpiece-surface contour of the workpiece-surface; and
forming the holes in the workpiece using through holes that extend through the body between the first jig-surface and a second jig-surface, wherein each one of the through holes comprises a through-hole axis that is perpendicular to the second jig-surface and that is non-perpendicular to the first jig-surface such that each one of the holes formed in the workpiece has a hole axis that is non-perpendicular to the workpiece-surface.

18. The method of claim 17, wherein forming the holes comprises one of drilling the holes or reaming the holes.

19. The method of claim 17, further comprising aligning the through holes with the holes in the workpiece such that the through-hole axis of each one of the through holes is non-perpendicular to the workpiece-surface and is coincident or parallel to the hole axis of each one of the holes.

20. The method of claim 17, further comprising aligning the through holes with drilling locations on the workpiece such that the through-hole axis of each one of the through holes is non-perpendicular to the workpiece-surface.
